(19) United States
(12) Patent Application Publication
(10) Pub. No.: US 2025/0162286 A1
(43) Pub. Date: May 22, 2025

(54) ILLUMINATING GLAZED ROOF

(71) Applicant: AGC GLASS EUROPE, Louvain-la-Neuve (BE)

(72) Inventors: Michel PIEROBON, Gosselies (BE); Héloïse ROELANDTS, Gosselies (BE); Jean-François NOULET, Grandmetz (BE)

(73) Assignee: AGC GLASS EUROPE, Louvain-la-Neuve (BE)

(21) Appl. No.: 18/832,556

(22) PCT Filed: Feb. 20, 2023
(86) PCT No.: PCT/EP2023/054177

§ 371 Date: Jul. 24, 2024

(30) Foreign Application Priority Data
Feb. 24, 2022 (EP) 22158648.0
May 3, 2022 (EP) 22171484.3

(51) Int. Cl. B32B 17/10; B32B 3/30; B60J 1/00; B60Q 1/00

(52) U.S. Cl. CPC B32B 17/10036; B32B 3/30; B32B 17/10275; B32B 17/10293; B32B 17/10541; B32B 17/1055; B32B 17/10614; B60J 1/001; B60Q 1/0017; B32B 2255/20; B32B 2307/412; B32B 2307/7376; B32B 2457/12; B32B 2605/00

(57) ABSTRACT

The present invention relates to a lighting vehicle glazing (3), comprising (i) an external glass pane (10) having an outer surface (P1) and an inner surface (P2) and an edge and (ii) an internal glass pane (11) having an outer surface (P3) and an inner surface (P4) and an edge (110), (iii) the first and the second glass panes (10, 11) being laminated together via at least a first plastic interlayer (14) having a thickness T1, (iv) a light-conducting plastic interlayer (12) having a thickness T2 lower than T1 in contact with the outer surface (P3) of the internal glass pane (11), the said light-conducting plastic interlayer being configured to conduct light coupled in at one of its end sides, which is materially bonded to the internal glass pane (11), (v) at least one light source (16) which is arranged such that light is coupled in at least one end side (122) of the light-conducting layer and/or at an end side (110) of the internal glass pane (11). According to the present invention, the light-conductive plastic interlayer (12) comprises a thermoplastic interlayer (120) provided with a functional layer (121) comprising light scattering particles applied to at least the surface the thermoplastic interlayer (120) in contact with the outer surface (P3) of the internal glass pane (11) and the light-conductive plastic interlayer (12) has decoupling means (13), via which a light exit of conducted light from the light-source (16) is caused on at least one of the light-conducting layer's main surface.

### FIELD OF THE INVENTION

The present invention relates to an illuminating glazing unit for vehicles, particularly an illuminating glazing unit forming part of the roof of a motor vehicle.

### BACKGROUND OF THE INVENTION

Today, car manufacturers are looking for illuminating glazing having a uniform diffusion of light and being aesthetic. It is also more and more requested to add some pattern into the glazing over at least one part of its surface. However, having a pattern may affect the uniformity of the lighting.

An interior light for a means of transportation is known from document DE 10360729 B4, in which an interior light is integrated with a printed circuit board having light-emitting diodes and electronics in a composite glass pane.

DE 10204359 A1 describes a device for illuminating an automotive sunroof. However, the structure of the device described therein is rather complex and leads to an increased thickness of the sunroof part. This thickness increase unavoidably leads to a reduction of the headspace of the driver and to an increase of the vehicle weight.

DE 10 2012 109 900 B4 describes illuminable glazing for an automotive sunroof comprising a light guiding layer made with light scattering particles embedded therein or with a physically modified surface.

However, there is still a need for improved illuminable glazing.

One object to be achieved is to specify an improved concept for glazings, which is more flexible to handle and enables a simplified production sequence.

These objectives have been achieved by the vehicle glazing according to the present invention as defined in claim 1. Further achievements have been attained by the subject-matters respectively defined in the dependent claims.

The improved concept is based on the idea of providing individual components of a vehicle glazing with illumination function separately, and subsequently combining them to form a composite using conventional production methods. Thus, the lighting function may be combined more easily with others functions such as thermal protection including coatings, switchable films, touch function. Accordingly to one object of the invention, a light source is also provided separately and can be attached without additional steps to the arrangement, which also enables simple replaceability of the light source, for example, for maintenance purposes. By way of the improved concept, production costs and also storage costs of the individual components of the overall arrangement can be reduced.

In one embodiment of the improved concept, a vehicle glazing comprises an external glass pane and an internal glass pane, which e.g. is formed from toughened glass, at least a first plastic layer, a light-conducting layer in contact with the inner face of the internal glass pane, and a light source. The light-conducting layer is configured to conduct light coupled in at one of its end sides and has decoupling means, via which a light exit of conducted light is caused on at least one of its main surfaces. The light-conducting layer is materially bonded to the pane. The light source is arranged such that light is coupled in on at least one end side of the light-conducting layer. Furthermore, the at least first plastic interlayer is arranged between the pane and the light-conducting layer, which has a lower index of refraction than the internal glass pane. The at least first plastic interlayer is implemented as a lamination layer. In some embodiments, the light-conducting layer has a thickness of T2.

Planar emission of light, which is coupled laterally into the layer, is enabled by way of the light-conducting layer having the decoupling means. Due to the at least first plastic interlayer, for example, light which is guided in the light-conducting layer does not reach the refractive layer, but rather is reflected back into the light-conducting layer. This causes, inter alia, a higher light yield and better light transport in the light-conducting layer. By having the light deflected by the plastic interlayer, it can be spread or diffused more widely to reduce problems caused by more direct illumination from point sources. The plastics interlayer may be substantially transparent; it may be neutral or clear in color or it may be body tinted.

In addition, the at least first plastic interlayer prevents light from being radiated through the external glass pane, i.e. light from the vehicle interior reaching the outside, for example. The pane itself can be a conventional pane, which is not affected by the light guiding or light emission.

A uniform optical impression can be achieved by the thermoplastic interlayer.

In one embodiment, the at least first plastic interlayer is preferably, a polyvinyl butyral film, PVB film. In some embodiments, the first plastic interlayer has a thickness of T1. In different embodiments, the thickness of light-conducting layer (T2) is lower than the thickness of the first plastic interlayer (T1), i.e., T2<T1.

The external and the internal glass panes can be flat soda lime glass, notably float glass. One or both of the glass sheets may be clear glass, extra clear glass or body tinted glass. Particularly when intended for use in window applications, the glazing panel may be substantially transparent. In this case, it may have a light transmission (CIE Illuminant C) of greater than or equal to 40%, 50%, 60% or 70% and/or a level of haze of less than or equally to 5%, 3% or 2% for example. Particularly when intended for decoration and/or lighting purposes, it may be unnecessary and/or undesired for the panel to be substantially transparent. In this case, it may have a light transmission (CIE Illuminant C) of less than or equal to 20%, 10%, or 5% and/or a level of haze of greater than or equally to 30%, 40% or 50%.

In a preferred embodiment, the internal glass pane is an extra-clear glass pane.

The surface fraction of the light-conduction layer in which the decoupling means are provided can be varied from a small fraction up to a complete surface embodiment depending on the application. In a preferred embodiment, the light-conduction layer is provided over the complete surface of the inner face of the internal glass pane.

The arrangement of the light source outside the composite of pane and light-conducting layer enables a complex lamination of an illumination unit into a composite glass pane to be omitted. In addition, the necessity is dispensed with of conducting required electrical energy for an illumination unit into the composite glass pane, since in a vehicle glazing according to the improved concept, light coupling is performed directly or via corresponding optical waveguides into the light-conducting layer.

Due to the special arrangement of the light source on the edge of the composite or the light-conducting layer, the light source, which is formed from LEDs, for example, is also subjected to less thermal stress than when it is laminated into the glazing. Furthermore, the light source is less in contact with the interlayer leading to less chemical interactions between the light source and the interlayer (lifetime of light source increased). In addition, the light source can be replaced easily, so that destruction of the composite between pane and light-conducting layer does not occur.

The light source is preferably one or more modules including light-emitting diodes (LEDs), each including a plurality of light-emitting diodes and associated electronic components fixed to a printed circuit board, the modules being positioned such that emitting faces of the LEDs are turned toward the edge of the first sheet of glass.

The LED modules are preferably chosen so that the thermal energy given off per unit of length of a module when the module is switched on is the most efficient. For example, the thermal energy given off per unit of length of a module when the module is switched on is less than 1.5 W per decimeter, preferably 1 W per decimeter, even more preferably in less than 0.5 W/dm.

The thermal energy given off by the LED modules depends not only on their electricity consumption, expressed in watts, but also on the light output. In fact, for a given level of electricity consumption, the heat given off increases as the light output decreases. However, this does not in any way mean that an attempt is made in the present invention to use LED modules with a low light output which give off a large amount of heat. The reason why the present invention is additionally defined with the aid of this parameter is simply that, below a certain level, the heat generated by the modules does not lead to an undesired temperature increase, and the technical problem of the shortening of the life of the LEDs is present to a lesser degree or even entirely absent.

However, a person skilled in the art will understand that it is difficult to define a precise threshold for this value, which depends on factors that may include the state of confinement of the LED modules, the resistance of the LEDs to high temperatures, or the degree of shortening of the life of the LEDs that is considered acceptable.

In another embodiment, the light source is optical fibers to transmit light, a waveguide combined with LEDs or laser diodes.

According to another embodiment, the light source may be encapsulated onto the edge of the glazing. The encapsulation means may be an element prepared by injection molding or may be a preformed bead, such as a bead of adhesive or elastomer, applied and fixed at the border of the glazing unit, on the first main face of the first sheet and also, if necessary, on the first main face of the second sheet if the geometry of the border of the glazing unit is suitable for this.

The light source may be fixed onto the edge of the glazing by means of a resin or an optical glue. Thus, the light source and in particular the LEDs and its associated electronic components fixed to a printed circuit board are fixed onto the edge of the glazing with a polymeric material such as silicon, epoxy, polyurethane. Thanks to the optical resin, the beam shape from the light source may be adapted. Thus, the light source is protected from moisture while the right transparent level to allow the right light injection into the glass is maintained.

The present invention allows to make significant reductions in losses of light by absorption, another possible way of obtaining higher illuminating power would be to use more powerful light sources.

In various embodiments, a holding element can optionally be provided on the glazing, which enables fastening on a vehicle body of the vehicle. Additionally or alternatively, an optional foam embedding of the edge region of the composite made of pane and light-conducting layer can be provided, which can also enclose the light source.

In some embodiments of the vehicle glazing, the light-conducting layer extends over the entire surface of the inner surface of the internal glass pane, so that the pane and the light-conducting layer form a composite glass, respectively. In a minor alteration thereof, it is also possible that the light-conducting layer extends over the entire surface of the pane with the exception of an edge region of the pane.

In alternative embodiments, the light-conducting layer is attached in one or more partial regions of the surface of the pane. For example, the light-conducting layer has a strip shape or a ring shape and preferably extends on one or more edges of the pane. Decoupling of the light from the light-conducting layer is performed in this case, for example, both perpendicularly to the main surface of the pane or the light-conducting layer and also at the edge facing away from the light source or the end side of the light-conducting layer facing away from the light source. A desired light mood can thus be achieved in particular.

According to the present invention, the light-conducting layer is formed from a transparent plastic, in particular from polyvinyl butyral, PVB. In particular, the decoupling means are formed, for example, by light-scattering particles applied on the surface of the light-conductive layer. The light-scattering particles are preferably not visible to the naked eye and cause a transparent impression of the plastic layer when the light source is turned off. The embedded particles cause scattering of the light at the particles, so that it is incident at an angle on the surface of the light-conducting layer, which enables an exit. By having a PVB film comprising light-scattering particles provided on the surface of the plastic interlayer, the refractive index will be the same than the PVB interlayer film used to laminate the glazing.

In other embodiments, within the light-conducting layer using, the decoupling means may be formed by structuring of a surface of the light-conducting layer. The structuring is preferably embodied on the entire surface of the light-conducting layer. Alternatively, a desired illumination image can be generated by only regional structuring. Furthermore, the main surface of the light-conducting layer, which faces toward the pane, is preferably structured. The structuring of the surface can be performed, for example, by mechanical structuring, for example, impression of structures, by printing, in particular using a pad print, by etching, or by a blasting method, for example, sandblasting.

The light-conducting layer is implemented as a flexible film and thin plastic interlayer.

Such a flexible film may be laminated onto the pane with low production technology expenditure and in the same way of lamination of a classical thermoplastic interlayer to bond for example two glass panes together.

In the above-mentioned embodiments, the glazing is a glazed roof.

The surfaces of the glass panes are typically referred to as follows. The outer side of the outer pane is referred to as side 1 (P1, face 1). The inner-side of the outer pane is referred to as side 2 (P2, face 2). The outer side of the inner pane is referred to as side 3 (P3, face 3). The inner-side of the inner pane is referred to as side 4 (P4, face 4).

In the above-mentioned embodiments, low-E coating (low-emissivity layers), as reflective thermal radiation coating, may be provided over the surface of a face of the glazing (P4) and more particular on the glass roof which is turned toward the passenger compartment. Thus, a glazed roof provided with a thermal radiation reflective coating and more particularly a low-E coating provides a best possible compromise between vision outside through the roof and good thermal properties thanks to its long-waves infrared (IR) energy reflection properties.

According to one embodiment of the present invention, the thermal-radiation-reflecting coating can also be referred to as a coating with low emissivity, an emissivity-reducing coating, low-E coating, or low-E layer. Its role is to reflect thermal radiation, i.e., in particular, IR radiation of longer wavelength than the IR component of solar radiation. At low outside temperatures, the low-E coating reflects heat back into the interior and reduces the cooling of the interior. At high outside temperatures, the low-E coating prevents the absorbed thermal radiation of the heated glazing to be re-emitted toward the interior and reduces the heating of the interior. On the interior side of the inner pane, the coating according to the invention reduces the emission of thermal radiation from the pane into the interior particularly effectively in the summer and reduces the transmission of heat into the external environment in the winter.

It is chosen to place the coating in position 4 despite the fact that in this position the layers are not protected from degradation, especially mechanical degradation. It is possible to choose low-E layers that are mechanically and chemically resistant enough.

Advantageously, for good mechanical resistance, the coatings are “hard” layers, such as those produced by PECVD, CVD or pyrolytic techniques. However, low-E systems may also be produced using vacuum cathode sputtering techniques, provided that the systems obtained are composed of layers that are sufficiently resistant.

According to the invention, it is preferred to use a low-emissivity coating system the emissivity of which is lower than 0.3 and preferably lower than 0.2 and in a particularly preferred way lower than 0.1.

The most common pyrolytic low-E (low-emissivity) systems comprise a layer of doped tin oxide deposited on a first layer having the role of neutralizing color in reflection. The layer making contact with the glass is ordinarily a layer of silica or silicon oxycarbide, optionally modified by additives. Tin oxide layers, compared to the layers of systems deposited by cathode sputtering, are relatively thick, i.e. more than 200 nm and in certain cases more than 450 nm in thickness. These thick layers are sufficiently resistant to withstand exposure to mechanical and/or chemical attack.

According to an embodiment, a filtering infrared radiation coating may be provided over the inner face (P2) of the outer glass pane. The coating may be provided over the inner face (P3) of the inner glass pane. The coating comprises one or more metal layers essentially based on silver combined with dielectric layers which, on the one hand, protect the metal layers. An infrared reflective coating may be present within the glazing, typically facing the intermediate PVB layer, such the coating is positioned in P2 or P3. The infrared reflective coating preferably comprises n infrared reflective (IR) layers and n+1 dielectric layers, with n≥1, such that each IR layer is surrounded by two dielectric layers. The IR layers may be made of silver, gold, palladium, platinum or alloys thereof, while the dielectric layers may typically comprise oxides, nitrides, oxynitrides or oxycarbides of Zn, Sn, Ti, Zr, Si, In, Al, Bi, Ta, Hf, Mg, Nb, Y, Ga, Sb, Mg, Cu, Ni, Cr, Fe, V, B or mixtures thereof. The role of the IR reflective coating is to reflect the infrared portions of the solar radiation. Typical infrared reflective coating may be provided by physical vapor deposition, so as to form coatings having a thickness ranging of from 10 to 250 nm.

According to an embodiment, a solution, such as an electrically powered functional film, for modifying the light transmission of the glazing, adjusting tint, privacy, diffusing reflection, for thermal protection, is provided between the outer glass pane and the at least one thermoplastic interlayer the conditions of use have already been proposed. Thus, the glazing may comprise a functional film such as electrochromic means in which the variation is obtained by modifying the state of colored ions in compositions included in these glazings. It is also a question of glazings comprising, in suspension, layers of particles that, depending on the application of an electric voltage, are or are not ordered, such as the systems referred to as suspended particles devices (SPDs), or in a preferred embodiment a polymer-dispersed liquid-crystal (PDLC) film consisting of a polymer containing liquid crystals sensitive to the application of the electric voltage or guest host liquid crystal (GHLC). These functional films allow the light level in the passenger compartment to be modified, their function is also to modify the antiglare effect and the level of privacy. Another role of these films is to protect the interior of the passenger compartment from heat. In particular, these functional films are films that are switchable between a dark state and a translucent or even transparent state.

The glass panes used to form the laminated glazing unit may have the same composition and possibly the same thickness, which may make them easier to shape beforehand, the two sheets being bent simultaneously for example. Most often the glass sheets have different compositions and/or thicknesses, and in this case they may be shaped separately.

The possible presence of colored interlayers participates in the absorption of light. Their use may be envisioned as a partial substitute at least to the contribution of the glass sheets to establishing a particular color. This situation may arise, for example, when, in order to integrate photovoltaic elements into the glazing unit, at least the external glass sheet is a sheet of poorly absorbent glass or even extra-clear glass. However, the external sheet may also be a sheet of absorbent glass, and there is no need for a colored interlayer. Thus according to one embodiment of the present invention, the light source or a functional film powered electrically may be powered thanks to the photovoltaic cells. The energy produced by the photovoltaic cells may be used also to power some other elements of the vehicle.

The internal glass pane turned toward the passenger compartment may also, be made of clear glass and more preferably of extra-clear glass. It is most often absorbent and contributes to the overall decrease in energy transmission. When its transmission is limited, it allows non-transparent elements present in the glazing unit to be at least partially masked from the sight of passengers. The internal glass pane may have structuring of its outer surface (P3) of the internal glass pane. The structuring is produced mechanically, for example, by imprinting the structure into the surface, for example. Alternatively, the structuring can be caused by printing, in particular using a pad print, so that the printed material represents the scattering structures. A further possibility for the structuring of the surface of the layer consists of etching of the surface, by which the surface is roughened to generate the scattering effect. Furthermore, the roughening or structuring can also be achieved by a blasting method, for example, by sandblasting.

According to one embodiment of the present invention, the internal glass pane is provided with a notch. Thus, the lateral edges (i.e edges of the glass coming from the windshield to the backlite) is provided with an offset inboard from the edge of the outer glass layer along at least a portion of the length in order to facilitate the mounting of the light source. More preferably, the offset is not provided along the entire periphery on the internal glass pane. In a preferred embodiment, the notch does not extend to the extremities of the internal glass pane, the offset is then not provided along the entire length of the periphery of the internal glass pane. The notch and more particularly the edge of the notch is preferably higher than 5 millimeters and more preferably higher than 10 millimeters from the edge of the outer glass pane. Thus, for example an array of LEDs may be typically mounted to the outer glass layer in the exposed area where the two glass layer edges are offset from each other. The light is injected into the edge of the inner glass layer. The notch allows also to correctly position the glass during the assembly.

According to one embodiment of the present invention, the internal glass pane is provided with an oblong hole. The oblong hole is preferably provided in the vicinity of the lateral edges of the internal glass pane. Thus, the light source is then provided preferably within the oblong hole.

According to another embodiment of the present invention, the internal glass pane is provided with a notch having its the edges grinded with a polished surface finish, to increase visible light transmission. The edges may also be ground to a convex, concave or other contour to help focus the light inboard of the edge. In a preferred embodiment, the edges of at least the notch are ground to a flat profile (simple chamfer) and polished to facilitate the entry of light in the internal glass pane from the light source. The edge is then more optically transparent to the light from the light source.

According to an embodiment, the lighting glazing is a roof glazing for vehicle. The roof glazing may be bonded directly to the vehicle or to an assembly which is then mounted to the vehicle. Whether directly bonded to the vehicle or an assembly, encapsulated in a molding.

The color in transmission and reflection is also important in the choice of the sheets of glass and interlayers.

The various described embodiments of the vehicle glazing enable modular applicability. In particular, the light-conducting layer can be combined with existing panes or roof glazings, without substantial design changes being necessary. The light-conducting layer can be constructed so that it has no or only a slight influence on force-transmitting elements of the vehicle glazing.

According to the present invention, the light-conductive layer comprises light scattering particles applied to at least one surface of the polymer interlayer film, wherein the polymer interlayer film comprises polyvinyl butyral. Preferably, the content of plasticizer in the polymer interlayer film before lamination is equal to or less than 5%.

One advantage of using a polyvinyl butyral (PVB) polymer interlayer film with very little or no plasticizer is the possibility to generate a film with a particularly smooth surface and thus a better, homogeneous print image on the smooth side. Also, the polyvinyl butyral material used for film is naturally very compatible with the standard PVB interlayers used in the glass industry. Furthermore, the a plasticizer-free and therefore stiff PVB film can be printed on using new, more economical roll-to-roll processes such as flexographic printing. This is not possible with glass or soft PVB films.

Preferably, the polymer interlayer film also comprises homo-or copolymers of (meth) acrylates, poly (vinyl) acetals, ionomers like ethylene methacrylic acid copolymers, nitro cellulose, polystyrenes, thermoplastic polyurethane, polycarbonates, polyvinyl chloride, polyolefins like polyethylene or polypropylene, polyethylene terephthalate, ethylene-vinyl acetate or mixtures thereof.

The light scattering particle are typically applied to the at least one surface of the polymer interlayer film by means of a coating or printing process. In case of printing, they can be applied via techniques that are commonly known in the printing industry such as offset printing, rotogravure printing, flexography, screen-printing and inkjet printing.

The thickness of the functional layer (T2) is preferably 0.1 μm to 100 μm, more preferably 1.0 μm to 30 μm before lamination.

The functional layer preferably comprises the light scattering particles and at least one matrix material. Suitable matrix materials include polymers in which the light scattering particles can be homogenously dispersed without decomposition. Preferably, the matrix material comprises homo-or copolymers of (meth) acrylate, methyl methacrylate, poly (vinyl) acetal, nitro cellulose, polystyrene, poly vinyl alcohol, polyurethane, poly carbonate and polyvinyl chloride. Most preferably, the matrix material is polyvinyl butyral.

Further components might be present in the functional layer. Examples of further components include co-resins, solvents, UV absorber, UV-stabilizer, cross-linker, curing agents, accelerants, photo-initiators, surfactants, stabilizers, filler, thixotropic modifiers and plasticizers.

Light scattering materials known in the art can be employed. Preferably, the light scattering particles are chosen from the group consisting of TiCh, TiO2, ZnO, AI203, ZrCh, Zr02, PbSCh, PbSO4, BaSCh, BaSO4, CaCO3, glass, polymers and mixtures thereof. The light scattering particles can be used as solid or hollow beads or fibers.

Preferably, the light scattering particles are present in the functional layer in an amount of 0.1 to 10% by weight, more preferred 0.5 to 5% by weight, most preferably 1 to 2.5% by weight.

The suitable light-conductive layer suitable according to the present invention is described in the patent application WO2021005162.

Preferably, the functional layer completely covers the at least one surface of the polymer interlayer film.

Also preferably, the functional layer covers only part of the polymer interlayer film. Thus, the functional film can be applied in form of a pattern and illumination in form of certain pattern can be achieved, which is not possible in case the light scattering particles are evenly dispensed in the laminate. Thus, preferably, the functional film covers equal to or less than 90%, 80%, 75% and most preferably less than 50% of the at least one surface of the polymer interlayer film. This embodiment is especially useful for informative and/or decorative glazing for aircrafts, trains or ships and for use in the construction area, especially for shop windows, elevators or facade glazing.

The thickness of the functional layer is preferably from 0.1 to 50 um, more preferably, from 1 to 30 μm, most preferably from 2 to 20 um as measured by IR microscopy. Depending on the location where the final glazing is used, e.g. in case of an automotive sunroof, the external glass pane, which faces the sun, may often be tinted in order to reduce the solar energy which is transmitted through the laminate into the vehicle. Thus, an electrically powered function film such as a PDLC, SPD, or other known switchable film as described above may be used between the external glass pane and the light-conductive layer, where it would be absorbed and lost for the purpose of illumination. Generally, the switchable film is laminated between at least two plastic interlayers such as PVB, EVA . . . and is provided between the external glass pane and the light-conductive layer. The switchable film may be surrounded, like a frame, by an thermoplastic interlayer and then the assembly is laminated between at least two plastic interlayers.

For forming the functional layer a printing ink, consisting of 0.40% by weight titanium dioxide (as light scattering particles) with a particle size D50 of 0.15 um determined by laser diffraction method according to DIN 13320, 27.0% by weight of poly (methyl methacrylate) (PMMA) (as matrix material) and 36.3% by weight of 2-butoxyethanol acetate and 36.3% by weight of cyclohexanone (as sacrificial solvents), was chosen.

The invention will be explained in greater detail hereafter on multiple exemplary embodiments on the basis of the figures. Elements which have equivalent function or action bear the same reference signs in this case. Insofar as individual elements are described for one of the figures, the description thereof in the following figures is not necessarily repeated.

### IN THE FIGURES

FIG. 1 shows a top view of a vehicle roof having a transparent roof part,

FIG. 2 shows an embodiment of an arrangement according to the invention,

FIG. 3 shows an embodiment of an arrangement according to the invention,

FIG. 4shows a further embodiment of an arrangement according to the invention,

FIG. 5 shows a further embodiment of an arrangement according to the invention,

FIG. 6 shows a further embodiment of an arrangement according to the invention,

FIG. 7 shows a further embodiment of an arrangement according to the invention.

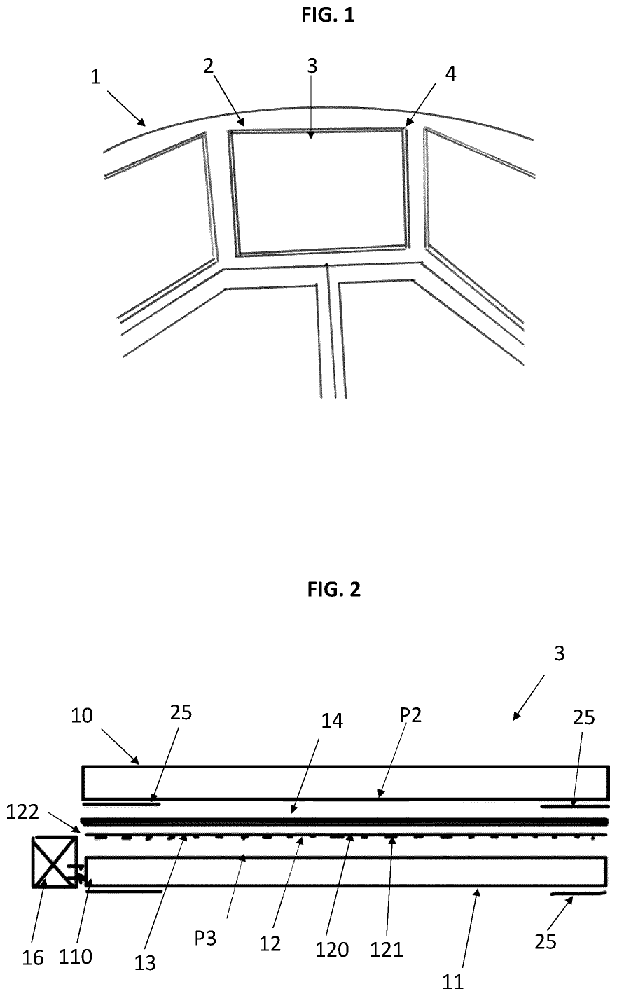

FIG. 1 shows a passenger automobile 1, which a vehicle roof 2 having a roof part in the form of a glazed roof 3, which is arranged in a roof opening 4. The cover 3 is implemented, for example, as a laminated vehicle glazing. The glazing unit according to the invention is preferably mounted on the vehicle in such a way that the internal glass pane is the one in contact with the passenger compartment of the vehicle and the external glass pane is the one located nearer the outside of the vehicle, commonly in direct contact with the atmosphere outside the vehicle.

FIG. 2 shows an embodiment of a vehicle glazing 3 having an external glass pane 10 and an internal glass pane 11. The external glass pane may a tinted glass. A light-conducting layer 12 is provided over the inner face (P3 also called face 3) of the internal glass pane 11. The light-conductive layer 12 comprises light scattering particles applied to at least one surface of the polymer interlayer film 12. In one embodiment, the scattering particles 121 are provided on the PVB 120 by ink printing. The light-conductive layer 12 is bonded to the internal glass pane 11 over its inner surface P3 by lamination. The light-conductive layer 12 extends over the entire surface of the inner surface (P3) of the internal glass pane 1. In the vehicle glazing of FIG. 2, a light source 16 is additionally provided, which is arranged such that light is coupled in at an end side 122 of the light-conducting layer 12 and/or at an end side 110 of the internal glass 11.

A opaque band 25 along the periphery of the glazing is provided to protect and to hide unesthetic element as glue, the fixation means . . . fixed on the glazing. The black band is well known for skilled man in the art. The black band, generally an enamel, may be provided at the periphery of the inner face P2 of the external glass pane 10 and the outer face P4 of the internal glass pane 11. The black band may be provided only in the inner face P2.

The internal glass pane 10 may be a clear glass and the internal glass pane 11 may be an extra-clear glass.

The light source 16 is provided in the way that the light is emitted perpendicularly to the edge 110 of the internal glass pane 11. The light-conducting layer 12 is configured in particular in this case to conduct light coupled in at the end side in the longitudinal direction through the layer. Furthermore, the light-conducting layer 12 has structuring 13 of the surface, which acts as the decoupling means for the light, so that a light exit of laterally coupled-in light is preferably caused via the lower main surface. The structuring 13 is provided in this case in particular on the side of the layer 12 facing toward the internal glass pane 11.

The decoupling is based on the effect that light is refracted or scattered on the structuring 13 and is therefore emitted at an angle which enables an exit from the surface of the layer 12. Without the structuring, the coupled-in light is typically incident at such a flat angle on the surface of the layer 12 that total reflection of the light occurs.

The structuring 13 of the surface of the layer 12 is produced mechanically, for example, by imprinting the structure into the surface, for example. Alternatively, the structuring can be caused by printing, in particular using a pad print, so that the printed material represents the scattering structures. A further possibility for the structuring of the surface of the layer 12 consists of etching of the surface, by which the surface is roughened to generate the scattering effect. Furthermore, the roughening or structuring can also be achieved by a blasting method, for example, by sandblasting.

The light source 16 is preferably one or more modules including light-emitting diodes (LEDs), each including a plurality of light-emitting diodes and associated electronic components fixed to a printed circuit board, the modules being positioned such that emitting faces of the LEDs are turned toward the edge of the first sheet of glass.

The light source 16 may be enclosed in a housing to fixed the light source on the glazing and also to protect it from external influences. The light source 16 may be encapsulated onto the edge of the glazing. The encapsulation means may be an element prepared by injection molding or may be a preformed bead, such as a bead of adhesive or elastomer, applied and fixed at the border of the glazing unit, on the first main face of the first sheet and also, if necessary, on the first main face of the second sheet if the geometry of the border of the glazing unit is suitable for this.

The LEDs may be side emitting LEDs or top emitting LEDs. Side emitting LEDs form a preferred embodiment. With side LEDs, the LEDs may be more easily placed perpendicularly to the plane of the internal glass pane 11 for a good coupling inside the internal glass pane 11.

In another embodiment, the light source 16, may be waveguides coupled with

LEDs or diode laser or optical fibers.

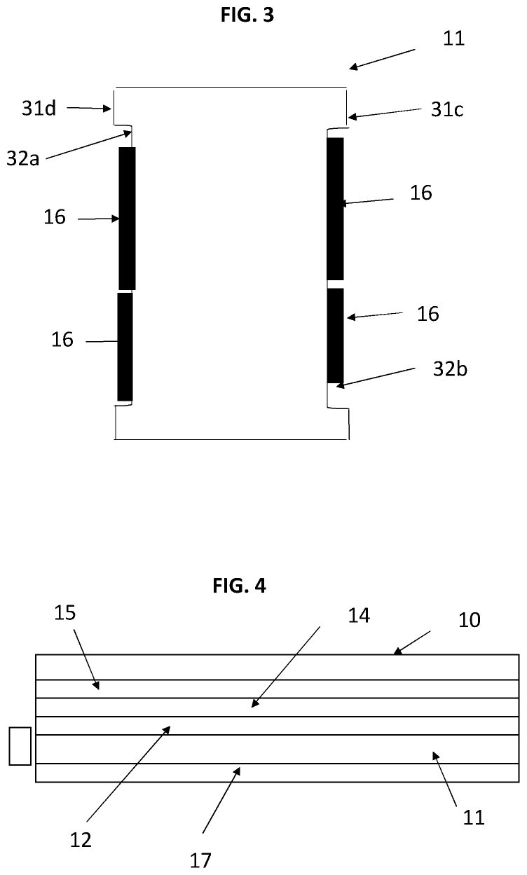

In a particular embodiment as shown in FIG. 3, the light-source 16 and in an embodiment, the LEDs modules are placed in a notch 32a, 32b, provided along at least a part of the lateral edges 31c, 31d of the internal glazing. The LEDs modules are then fixed on the external glass pane 10 for example by encapsulation means. The notch is distanced from the edge of the lateral edge of the internal glass pane 11 of a distance at least equal to the width of the light-source 16 and more particularly the LEDs modules. The light source is preferably encapsulated in encapsulation means in contact with the a partial region of the inner face (P2) of the external glass pane 10. The notch may be distanced from the edge of a distance lower than 20 mm.

A thermoplastic interlayer 14 is provided between the inner face (P2) of the external glass pane 10 and the light-conductive layer 12. The interlayer 14 can have multiple functions. On the one hand, it can be used as a lamination layer, which causes a permanent bond between the pane 10 and the layer 12. In addition, the interlayer 14 can be implemented as a refractive layer, which in particular has a lower index of refraction than the light-conducting layer. Light incident on the interface between the layer 12 and the layer 14 thus remains in the light-conducting layer 12 and does not pass into the internal pane 11 (nor external pane 10). Light absorption in the pane 11 or light exit from the vehicle into the surroundings is avoided in this way. The interlayer 14 is in a preferred embodiment a grey or colored PVB. The thickness of the PVB may the standard one as about 0.75 mm-0.8 mm. However, the thickness may be lower than 0.75 mm. In another embodiment, several thinner interlayer 14 may be superposed. The use of a grey PVB has the advantage of absorbing the light of the structuring 13 to concentrate the light inside the glazing and/or to decrease eventually a double image generated by the structuring 13 onto the external glass pane. It is particularly useful when the glazing is provided with IR-reflective coatings, . . .

Additionally, the interlayer 14 can exercise the function of a splinter protection layer or splinter protection film. For example, the layer 14 is implemented for this purpose from polyvinyl butyral (PVB). In some embodiments, the interlayer has a thickness of T1.

The interlayer 14 is preferably provided so that it acts both as a lamination layer and also as a refractive layer, and furthermore simultaneously as a splinter protection film. Alternatively, the three functions can also be caused by a corresponding layer structure of multiple films. The interlayer extends over the surface of the glass pane 10. Thus, laminated glazing including at least one light source which is provided with surface lighting with an improved uniformity. Another objective of at least some embodiments is to provide such a surface lighting panel which provides a more uniformly diffused surface lighting.

FIG. 4 shows a further embodiment of a vehicle glazing 3, which is based on the embodiment illustrated in FIG. 2. In this embodiment, an infrared (IR) reflective coating 15 may be provided over the surface of the inner face (P2) of the external glass pane 10 facing the at least first thermoplastic interlayer 14. The infrared reflective coating preferably comprises n infrared reflective (IR) layers and n+1 dielectric layers, with n>1, such that each IR layer is surrounded by two dielectric layers. The IR layers may be made of silver, gold, palladium, platinum or alloys thereof, while the dielectric layers may typically comprise oxides, nitrides, oxynitrides or oxycarbides of Zn, Sn, Ti, Zr, Si, In, Al, Bi, Ta, Hf, Mg, Nb, Y, Ga, Sb, Mg, Cu, Ni, Cr, Fe, V, B or mixtures thereof. The role of the IR reflective coating is to reflect the infrared portions of the solar radiation. Typical infrared reflective coating may be provided by physical vapor deposition, so as to form coatings having a thickness ranging of from 10 to 250 nm.

The role of the IR reflective coating is to limit the heat in the interior of the compartment of the vehicle.

Furthermore, an Low-emissivity coating 17, as reflective thermal radiation coating, may be provided over the surface of a face of the glazing (P4) and more particular on the glass roof which is turned toward the passenger compartment. Thus, a glazed roof provided with a thermal radiation reflective coating and more particularly a low-E coating provides a best possible compromise between vision outside through the roof and good thermal properties thanks to its long-waves infrared (IR) energy reflection properties.

FIG. 5 shows in another embodiment, a glazing 3 as described in FIG. 2 comprising further a film comprising photovoltaic cells 18. The film comprising photovoltaic cells 18 is bound to the external glass pane 10 with a thermoplastic interlayer 14b. Particularly, the film comprising photovoltaic cells 18 is sandwiched between at least two thermoplastic interlayers 14b, 14c. The thermoplastic interlayers are preferably made of PVB or EVA or PET. Photovoltaic cells are for example silicone crystallin (C-Si) solar cells, perovskite, tandem cells thin solar cells film or a combination of these solar cells.

The solar cells may be partially transparent or transparent areas can be formed by rows of solar cell wherein between each row natural light may pass through each row. In that case, it is preferable to use a colored thermoplastic interlayer 14b,c or a functional film such as PDLC, SPD . . . between the photovoltaic cells film and the light-conductive film 12 to avoid that natural light interfere with the light-conductive film 12.

The solar cells design may be fully opaque to the natural light, thus there is no need to have a functional film such as PDLC, SPD . . . between the photovoltaic cells film and the light-conductive film 12, in other words, whole glazing is covered with opaque solar cells.

Thus, the exterior light is captured by the solar cells through the external glass pane 10. The electricity generated by the photovoltaic cells may be used for the light source 16 or for any element from the glazing or the car which needs to be electrically powered.

As shown in FIG. 4, the external glass pane 10 may be larger than the internal glass pane 11.

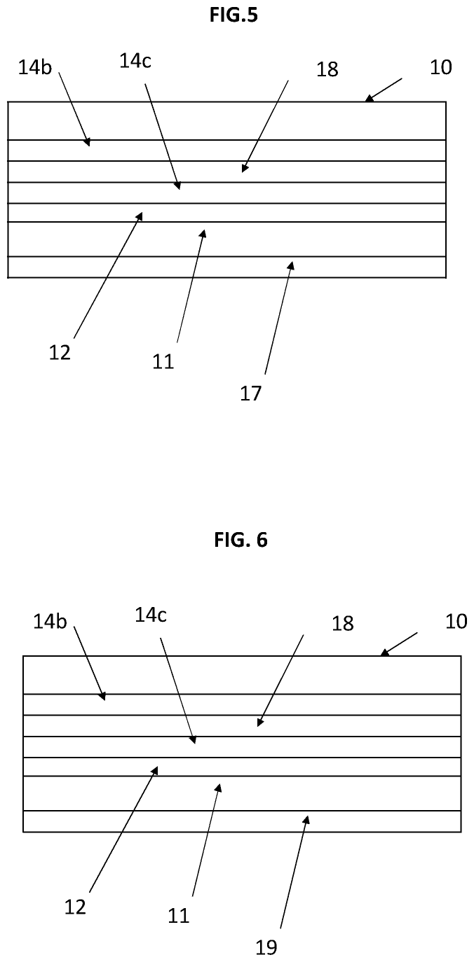

FIG. 6 shows in another embodiment, a glazing 3 as described in FIG. 2 comprising further an electrically powered functional film 19 chosen amongst the group of a PDLC film, a LCD film, a GHLC film, a SPD film, an electrochromic film. The electrically powered functional film 19 may be provided between the external glass pane 10 and the thermoplastic interlayer 14. The electrically powered functional film is bonded the external and internal glass pane with transparent polymer material commonly used for this purpose, for example poly (vinyl butyral) (PVB), thermoplastic polyurethane (TPU) or ethylene vinyl acetate copolymer (EVA). The interlayer may be free of plasticizer. The use of IR reflective coating in inner face (P2) OR P3 of the external glass pane to reduce heat caused by solar radiation can both improve performance of a switchable film embedded in the glazing 3 and improve comfort for occupants in a vehicle cabin having a laminated glazed roof. The thermal coatings 15 in the glazing 3 are located directly below the top, upper, or outermost external glass panel 10 to provide efficient heat reduction, providing thermal protection both to other optical components within the glazing 3 and, for example, to occupants within a vehicle cabin using the glazing 3.

In another embodiment, an assembly comprising photovoltaic cells may be provided over at least of part of the surface of the inner face (P2) of the external glass pane (10). The assembly comprising photovoltaic cells may used to electrically power the light source 16 and/or the electrically powered functional film such chosen amongst the group of a PDLC film, a LCD film, a GHLC film, a SPD film, an electrochromic film as described above or some other elements of the vehicle like partly the engine, the air-conditioning system. The assembly comprising photovoltaic cells may be laminated to the external glass pane 10 with a transparent polymer material such as poly (vinyl butyral) (PVB).

Thus, the invention propose a glazing and more particularly a glazed roof for vehicle combining lighting, photovoltaic cells film, and/or a functional film such as switchable films (PDLC, LCD, SPD, electrochromic . . . ) that are switchable between a dark state and a translucent or even transparent state while controlling the thermal properties of the glazing through the IR reflective coating and/or low-emissivity coatings.

In a preferred embodiment, the internal glass pane 11 is an extra-clear glass.

The extra-clear glass has a low absorption coefficient and allows the most efficient coupling of the light.

The external glass pane 10 may be a clear glass pane.

The thickness of the external and the internal glass panes 10, 11 may be the same of different. The thickness is preferably lower than 3 mm, most preferably lower than 2.5 mm. The external glass pane 10 and more the preferably the internal glass pane 11 is a thin glass sheet i.e., having thickness lower than 2.1 mm.

The external and the internal glass panes 10, 11 may be symmetric (same length) or asymmetric with the internal glass pane 11 being smaller than the external glass pane 10. In that embodiment, the light source 16 may be placed in the region not covered by the external glass pane and facing the edge 110 of the internal glass. The external glass pane 10 is used as a support for the at least one light source 16.

In an embodiment, the light-source 16 is provided in a notch formed in the internal glass pane 11. In a preferred embodiment, the notch is provided only in the area wherein the light-source 16 is placed. The light-source 16 is for in a preferred embodiment LEDs.

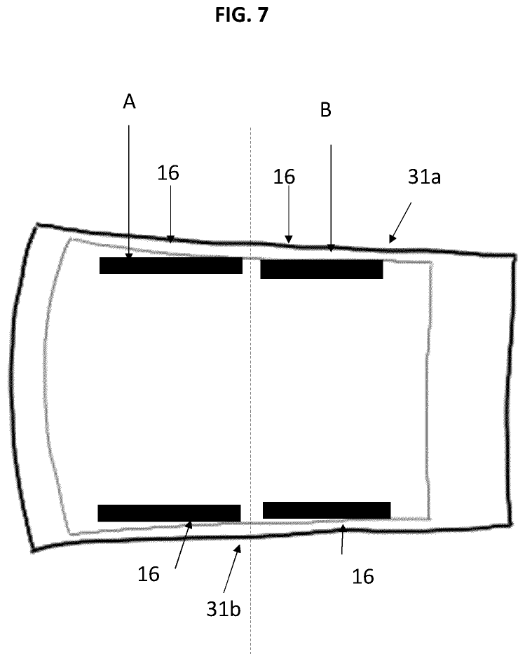

FIG. 7 shows a further embodiment of a vehicle glazing 3, in which a plurality of light source 16 is provided along the lateral edges 31a, 31b of the glazing. Thus, an uniform lighting may be obtained. Each of the light source 16 may be managed individually depending for example on the zones A and B to be illuminated. It is understood that more than 2 zones may be illuminated Thus, a segmentation may be provided. Each zone may further comprise a switchable film 19. The light source 16 and more particularly LEDs modules with each including a plurality of light-emitting diodes and associated electronic components fixed to a printed circuit board. the modules being positioned such that emitting faces of the LEDs are turned toward the edge of the internal glass pane and emit perpendicularly to the plane of the internal glass pane. The LEDs modules may be spaced from each other to a determined distance to have a uniform lighting within the glazing 3.

The LEDs modules are in an embodiment placed in a notch provided along at least a part of the lateral edges 31c, 31d of the internal glazing. The LEDs modules are then fixed on the external glass pane 10. The notch is distanced from the edge of the lateral edge of the internal glass pane 11 of a distance at least equal to the width of the light-source 16 and more particularly the LEDs modules. The light source is preferably encapsulated in encapsulation means in contact with the a partial region of the inner face (P2) of the internal glass pane.

Alterations and combinations of the described embodiments are, of course, possible and included by the invention.

Also for avoidance of doubt, the present invention is applicable for all means of transport such as automotive vehicle, vans, lorries, motorbikes, buses, trams, trains, airplanes, helicopters and the like. According to an embodiment of the present invention, the glazing may be a glazed roof, a sidelite, a backlite or a part of windshield of an automotive vehicle.

1. A lighting vehicle glazing (3), comprising:
an external glass pane (10) having an outer surface (P1) and an inner surface (P2) and an edge and
an Internal glass pane (11) having an outer surface (P3) and an inner surface (P4) and an edge (110),
the first and the second glass panes (10, 11) being laminated together via at least a first plastic interlayer (14) having a thickness T1,
a light-conducting plastic interlayer (12) having a thickness T2 lower than T1 in contact with the outer surface (P3) of the internal glass pane (11), the said light-conducting plastic interlayer (12) being configured to conduct light coupled in at one of its end sides, which is materially bonded to the internal glass pane (11),
at least one light source (16) which is arranged such that light is coupled in at least one end side 122 of the light-conducting layer and/or at an end side 110 of the internal glass 11,
Wherein the light-conductive plastic interlayer 12 comprises a thermoplastic interlayer (120) provided with a functional layer (121) comprising light scattering particles applied to at least the surface the thermoplastic interlayer (120) in contact with the outer surface (P3) of the internal glass pane (11) and the light-conductive plastic interlayer has decoupling means (13), via which a light exit of conducted light from the light-source (16) is caused on at least one of the light-conducting layer's main surface.

2. The vehicle glazing (3) of claim 1, wherein the light-conducting plastic interlayer has a pattern (13) over at least a part of one of its surface.

3. The vehicle glazing (3) of claim 1, wherein the light source (16) is one or more modules including light-emitting diodes (LEDs), each including a plurality of light-emitting diodes and associated electronic components fixed to a printed circuit board.

4. The vehicle glazing (3) of claim 1, wherein the light source (16) is one or more modules including light-emitting diodes (LEDs), each including a plurality of light-emitting diodes and associated electronic components fixed to a printed circuit board, the modules being positioned such that emitting faces of the LEDs are turned toward the edge of the internal glass pane and emit perpendicularly to the plane of the internal glass pane.

5. The vehicle glazing (3) of claim 1, wherein the light source (16) is placed in a notch (32a, 32b) provided in the internal glass pane (11) from its lateral edge (31c, 31d) and fixed onto the inner surface (P2) of the glass pane (10).

6. The vehicle glazing (3) of claim 1, wherein an electrically powered functional film (19) chosen amongst a PDLC, GHLC, LCD, a SPD, a electrochromic film is provided between the external glass pane and the first plastic interlayer.

7. The vehicle glazing (3) of claim 1, wherein a photovoltaic cells film (18) is provided between the external glass pane and the first plastic interlayer.

8. The vehicle glazing (3) of claim 1, wherein the light source (16) is side LEDs.

9. The vehicle glazing (3) of claim 1, wherein the light source (16) is encapsulated in encapsulation means in contact with the a partial region of the inner face of the internal glass pane.

10. vehicle glazing (3) of claim 1, wherein the light-conducting plastic interlayer (12) extends over the entire surface of the pane.

11. The vehicle glazing (3) of claim 1, wherein the light-conducting plastic interlayer (12) is formed from PVB.

12. The vehicle glazing of claim 1, wherein the light-conducting plastic interlayer (12) comprises light-scattering particles (121) provided by ink printed.

13. The vehicle glazing (3) of claim 1, wherein light-conducting plastic interlayer (12) has a structuring of the surface facing the outer face (P3) of the internal glass pane (11) formed by at least one of mechanical structuring; printing;
etching; and blasting.

14. The vehicle glazing (3) of claim 1, wherein the thickness T2 of the light-conducting plastic interlayer is lower than 0.050 mm and more preferably lower than 0.03 mm.

15. The vehicle glazing (3) of claim 1, wherein a solar control coating (15) is provided over at least the inner face (P2) of the external glass pane (10) or the outer face (P3) of the internal glass pane (11).

16. The vehicle glazing (3) of claim 1, wherein a low-e coating (17) is provided over at least a part of the inner face (P4) of the internal glass pane (11).

17. The vehicle glazing of claim 1, wherein the glazing is a glazed roof.
